(19) United States
(12) Patent Application Publication
(10) Pub. No.: US 2026/0139716 A1
(43) Pub. Date: May 21, 2026

(54) ELECTROMECHANICAL BRAKE ACTUATOR WITH IMPROVED WEAR ADJUSTMENT

(71) Applicant: ADVICS North America, Inc., Lebanon, OH (US)

(72) Inventor: Marshall BULL, Plymouth, MI (US)

(73) Assignee: ADVICS North America, Inc., Lebanon, OH (US)

(21) Appl. No.: 18/950,609

(22) Filed: Nov. 18, 2024

(51) Int. Cl. F16D 55/225; F16D 121/14; F16D 121/24; F16D 125/40

(52) U.S. Cl. CPC F16D 55/225; F16D 2121/14; F16D 2121/24; F16D 2125/40

(57) ABSTRACT

An electromechanical brake actuator includes a piston slidably movable within the bore of a housing, the piston having a pressing surface configured to apply a pressing force to a brake pad, a driving mechanism configured to drive the piston relative to the housing in an advancement direction such that the pressing force is applied and in a retraction direction opposite the advancement direction such that the pressing force is discontinued, a split ring clamped to one of the housing or the piston and configured to stop movement of the piston relative to the housing in the retraction direction at a standby position of the piston, wherein the split ring is configured to be positionally fixed to the other of the housing or the piston when the piston moves in the advancement direction from the standby position by a distance greater that the predetermined distance, thereby adjusting the standby position.

### TECHNICAL FIELD

The present disclosure relates to electromechanical brake actuators with improved wear adjustment.

### BACKGROUND INFORMATION

Electromechanical brake actuators face safety challenges that differ from those of hydraulic braking systems. One proposal is to include mechanical mechanisms for releasing brake actuation in the event of electrical failure. Further, in order to ensure reliable actuation, the standby position of such actuators should be adjustable to compensate for wear. An electromechanical brake actuator design that robustly operates according to the foregoing while minimizing cost and space is therefore desirable.

### SUMMARY

An electromechanical brake actuator includes a housing defining a bore, a piston slidably movable within the bore along a longitudinal axis of the bore, the piston having a pressing surface configured to apply a pressing force to a brake pad, a driving mechanism configured to drive the piston relative to the housing in an advancement direction such that the pressing force is applied and in a retraction direction opposite the advancement direction such that the pressing force is discontinued, a split ring clamped to one of the housing or the piston and configured to stop movement of the piston relative to the housing in the retraction direction at a standby position of the piston relative to the housing, wherein the split ring is configured to be positionally fixed to the one of the housing or the piston when the piston moves in the advancement direction from the standby position by a distance less than a predetermined distance, wherein the split ring is configured to be positionally fixed to the other of the housing or the piston when the piston moves in the advancement direction from the standby position by a distance greater that the predetermined distance, thereby adjusting the standby position.

### BRIEF DESCRIPTION OF THE DRAWINGS

Other features and advantages disclosed herein will become more apparent from the following detailed description of exemplary embodiments when read in conjunction with the attached drawings.

FIGS. 1A, 1B, and 1C illustrate a split ring in respective normal, expanded, and compressed configurations.

FIG. 2 illustrates an electromechanical brake actuator according to a first embodiment in a standby position.

FIG. 3 illustrates the electromechanical brake actuator according to the first embodiment in an actuated position before wear adjustment.

FIG. 4 illustrates the electromechanical brake actuator according to the first embodiment in an actuated position after wear adjustment.

FIG. 5 illustrates the electromechanical brake actuator according to the first embodiment in an adjusted standby position.

FIG. 6 illustrates an electromechanical brake actuator according to a second embodiment in a standby position.

FIG. 7 illustrates the electromechanical brake actuator according to the second embodiment in an actuated position before wear adjustment.

FIG. 8 illustrates the electromechanical brake actuator according to the second embodiment in an actuated position after wear adjustment.

FIG. 9 illustrates the electromechanical brake actuator according to the second embodiment in an adjusted standby position.

### DETAILED DESCRIPTION

Set forth below with reference to the accompanying drawings is a detailed description of embodiments of electromechanical brake actuators with improved wear adjustment, representing examples of an inventive electromechanical brake actuator with improved wear adjustment.

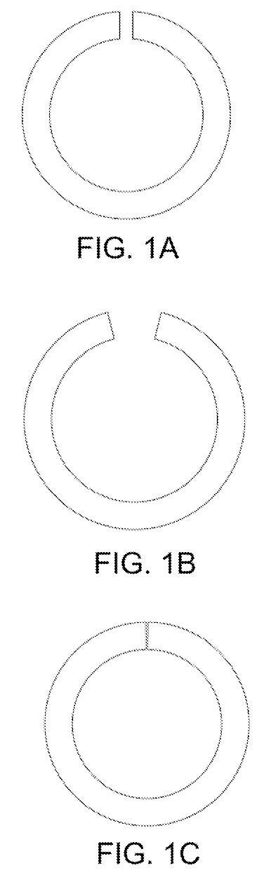

An electromechanical brake actuator according to exemplary embodiments utilize a split ring. An exemplary split ring is illustrated in FIGS. 1A, 1B, and 1C. In the normal position illustrated in FIG. 1A, the split ring does not exert any radial forces. When the split ring is expanded as illustrated in FIG. 1B, the split ring generates a radial inward clamping force. When the split ring is compressed as illustrated in FIG. 1C, the split ring generates a radial outward clamping force.

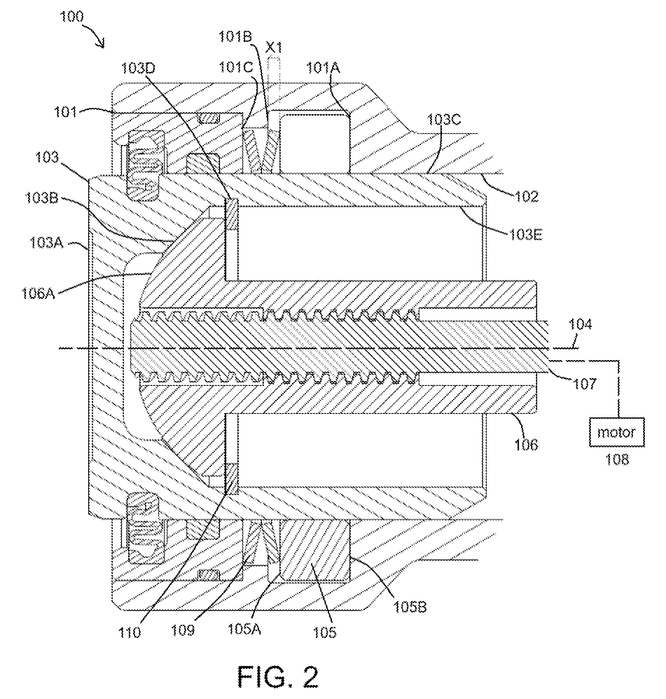

An electromechanical brake actuator 100 according to a first embodiment is illustrated in FIGS. 2-5. The actuator 100 includes a housing 101 defining a bore 102, and a piston 103 slidably movable within the bore 102 along a longitudinal axis of the bore 102. In particular, a radial outer surface 103C of the piston 103 has a cylindrical cross-sectional shape matching that of the bore 102. In this embodiment, the housing 101 has a two-piece structure for assembly purposes.

The piston 103 further includes a pressing surface 103A configured to apply a pressing force to a brake pad, a contact surface 103B, and a radial inner surface 103E. Fixed within a groove 103D in the radial inner surface 103E is a retaining ring 110. Sandwiched between the contact surface 103B and the retaining ring 110 is a head 106A of a nut 106.

The nut 106, in combination with a screw 107, together form a driving mechanism configured to drive the piston 103 relative to the housing 101 in an advancement direction such that the pressing force is applied and in a retraction direction opposite the advancement direction such that the pressing force is discontinued. In particular, the nut 106 is threaded to the screw 107 such that, when the screw 107 is rotated about the longitudinal axis 104 by a motor 108, the nut 106 linearly moves along the longitudinal axis 104. The motor 108 can be directly connected to the screw 107, or can be operatively connected to the screw 107 by a gear train, in a known manner.

The nut 106 moves in the advancement direction when the screw 107 rotates in a first direction, and moves in the retraction direction when the screw 107 rotates in a second direction opposite the first direction. When the nut 106 moves in the advancement direction, the head 106A presses against the contact surface 103B to drive the piston 103 in the advancement direction. When the nut 106 moves in the retraction direction, the head 106A presses against the retaining ring 110 to drive the piston 103 in the retraction direction.

The actuator 100 further includes a split ring 105 clamped to the outer surface 103C of the piston 103. In particular, the split ring 105 has an inner diameter in its normal configuration smaller than the diameter of the outer surface 103C, such that the split ring 105 is expanded when disposed on the outer surface 103C and thus exerts a radially inward clamping force which fixes the axial position of the split ring 105 on the piston 103.

The split ring 105 is further disposed between a stop surface 101A and a stepped surface 101B of the housing, such that an advancement-side surface 105A of the split ring 105 faces the stepped surface 101B and a retraction-side surface 105B of the split ring 105 faces the stop surface 101A. Disposed between the step of the stepped surface 101B and the outer surface 103C of the piston 103 is a retraction spring assembly 109 made up a plurality of disc springs. The disc springs are illustrated as stacked in alternating directions, but could be stacked in the same direction, or a combination of the two depending on the desired spring rate. The retraction spring assembly 109 bears against a spring-supporting surface 101C of the housing 101 on an advancement-direction side and on the advancement-side surface 105A of the split ring 105 on a retraction-direction side, thus applying an urging force in the retraction direction (i.e., a retraction force) on the piston 103 via the split ring 105.

FIG. 2 illustrates an initial standby position of the piston 103 relative to the housing 101. In the standby position, the retraction-side surface 105B of the split ring 105 is in contact with the stop surface 101A, and the advancement-side surface 105A is spaced apart from the stepped surface 101B by a predetermined distance X1 which is dependent on the axial thickness of the split ring 105 and the axial distance between the stop surface 101A and the stepped surface 101B. The predetermined distance X1 is set as the desired distance the piston 103 should move in order to fully engage the brake pad.

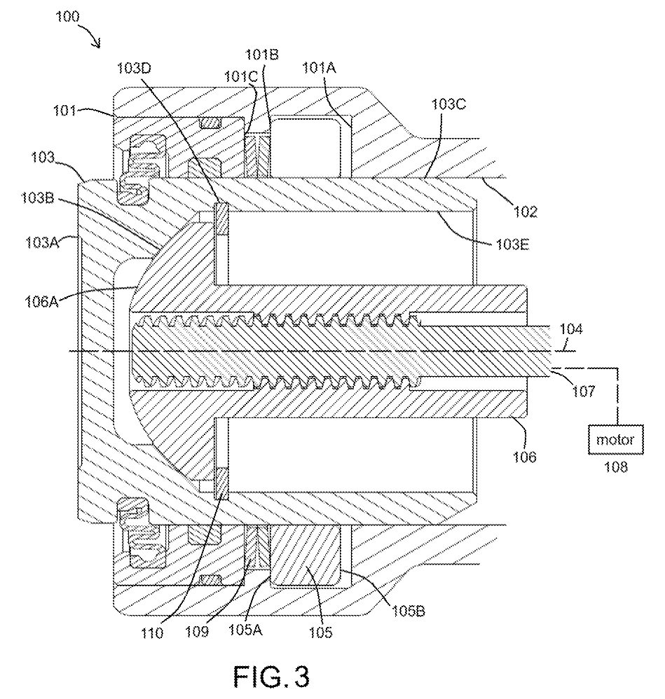

When the driving mechanism moves the piston 103 in the advancement direction from the standby position of FIG. 2, the split ring 105 travels with the piston 103 until the piston 103 has traveled the predetermined distance X1, at which point the advancement-side surface 105A is in contact with the stepped surface 101B, as illustrated in FIG. 3. Although this position is set as the desired position for full engagement of the brake pad, as discussed above, there is a possibility that the brake pad has worn, or has further worn since the last time the standby position was adjusted.

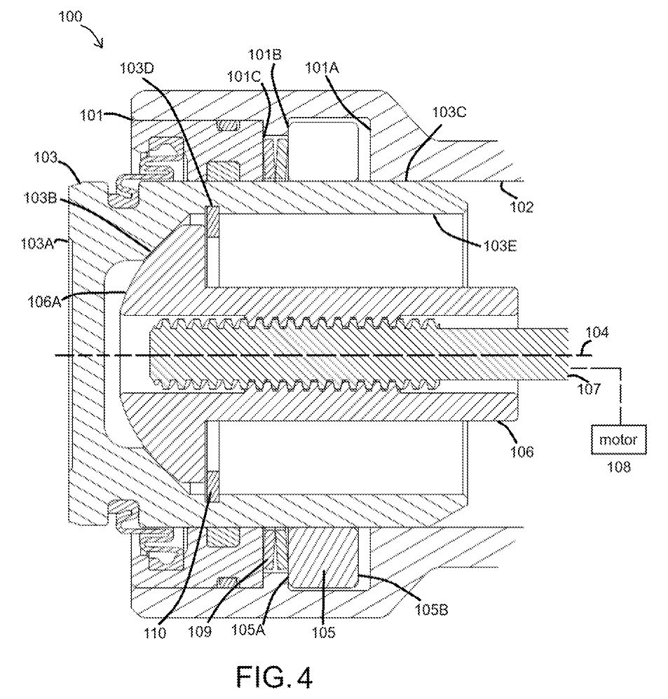

If the piston 103 is then moved further in the advancement direction, for example, because the brake pad has worn, or has further worn since the last time the standby position was adjusted, the friction force due to the clamping force of the split ring 105 on the piston 103 is overcome and the split ring 105 is held stationary, by the stepped surface 101B, relative to the piston 103 as the piston 103 further advances. FIG. 4 illustrates an example of such a further advanced position, e.g., a position in which the worn or further worn brake pad is fully engaged. The position of the split ring 105 relative to the piston 103 when the piston 103 is at this further advanced position will define a new standby position of the piston 103 relative to the housing 101, as discussed in detail below.

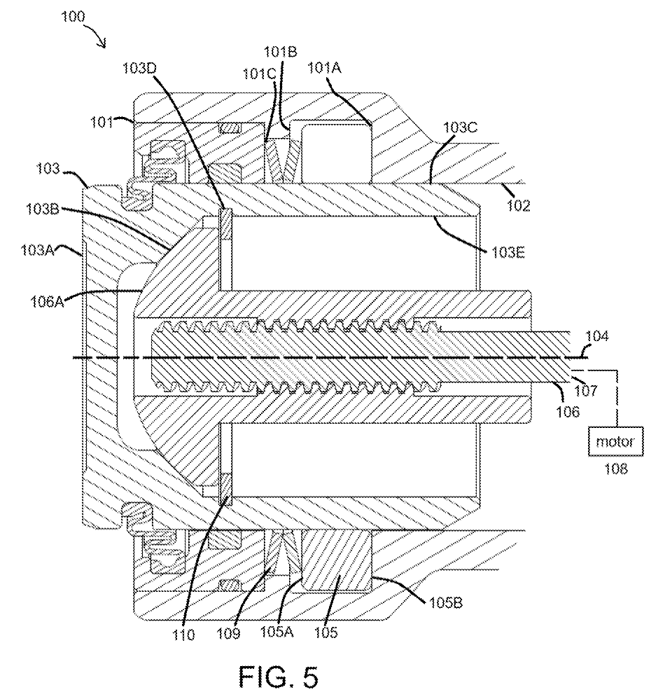

When a retraction force is applied to the piston 103, either by the driving mechanism, or in the event of a power failure, by the retraction spring assembly 109, the pressing force is discontinued and the piston 103 is moved in the retraction direction. During this movement of the piston 103 in the retraction direction, the split ring 105 remains clamped to the piston 103, and in the case in which the piston 103 had previously moved further than the predetermined distance X1 in the advancement direction, the position at the which the split ring 105 is now clamped to the piston 103 is different the position at the which the split ring 105 was clamped to the piston 103 prior to the movement in the advancement direction. As a result, the position of the piston 103 relative to the housing 101 when the retraction-side surface 105B of the split ring 105 is in contact with the stop surface 101A, i.e., the standby position, has changed, as shown in FIG. 5, to account for the wear or further wear of the brake pad. Thus, during subsequent actuations and until additional adjustment is needed, the piston 103 will only need to travel the predetermined distance X1 in the advancement direction to again fully engage the brake pad.

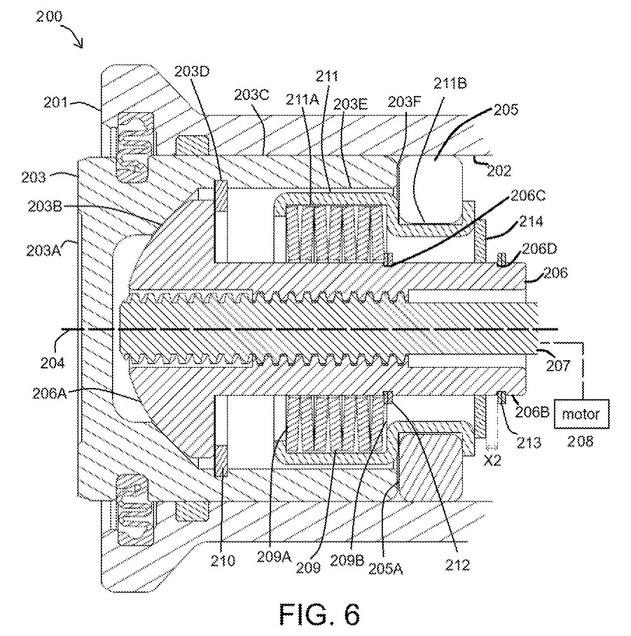

An electromechanical brake actuator 200 according to a second embodiment is illustrated in FIGS. 6-9. The actuator 200 includes a housing 201 defining a bore 202, and a piston 203 slidably movable within the bore 202 along a longitudinal axis of the bore 202. In particular, a radial outer surface 203C of the piston 203 has a cylindrical cross-sectional shape matching that of the bore 202.

The piston 203 further includes a pressing surface 203A configured to apply a pressing force to a brake pad, a contact surface 203B, and a radial inner surface 203E. Fixed within a first groove 203D in the radial inner surface 203E is a first retaining ring 210. Sandwiched between the contact surface 203B and the first retaining ring 210 is a head 206A of a nut 206.

The nut 206, in combination with a screw 207, together form a driving mechanism configured to drive the piston 203 relative to the housing 201 in an advancement direction such that the pressing force is applied and in a retraction direction opposite the advancement direction such that the pressing force is discontinued. In particular, the nut 206 is threaded to the screw 207 such that, when the screw 207 is rotated about the longitudinal axis 204 by a motor 208, the nut 206 linearly moves along the longitudinal axis 204. The motor 208 can be directly connected to the screw 207, or can be operatively connected to the screw 207 by a gear train, in a known manner.

The nut 206 moves in the advancement direction when the screw 207 rotates in a first direction, and moves in the retraction direction when the screw 207 rotates in a second direction opposite the first direction. When the nut 206 moves in the advancement direction, the head 206A presses against the contact surface 203B to drive the piston 203 in the advancement direction. When the nut 206 moves in the retraction direction, the head 206A presses against the first retaining ring 210 to drive the piston 203 in the retraction direction.

The actuator 200 further includes a split ring 205 clamped to the bore 202 of the housing 201. In particular, the split ring 205 has an outer diameter in its normal configuration greater than the diameter of the bore 202, such that the split ring 205 is contracted when disposed within the bore 202 and thus exerts a radially outward clamping force which fixes the axial position of the split ring 205 in the housing 201.

The actuator 200 also includes a retraction spring assembly retainer 211, which is a tubular member having a wall shaped to define a radially-outward facing channel 211B and a radially-inward facing channel 211A. The split ring 205 is disposed in the radially-outward facing channel 211B. The width of the radially-outward facing channel 211B essentially the same as that of the split ring 205, so that the split ring 205 and the retraction spring assembly retainer 211 move in the advancement and retraction direction together as a unit. A portion of an advancement side-surface 205A of the split ring that is not disposed within the channel 211B faces a stop surface 203F of the piston 203 that faces the retraction direction.

Disposed between the radially-inward facing channel 211A of the retraction spring assembly retainer 211 and the shank 206B of the nut 206 is a retraction spring assembly 209 made up a plurality of disc springs. The disc springs are illustrated as stacked in alternating directions, but could be stacked in the same direction, or a combination of the two depending on the desired spring rate. The retraction spring assembly 209 has a first, advancement-direction side 209A in engagement with a sidewall of the radially-inward facing channel 211A and a second, retraction direction side 209B in engagement with a second retaining ring 212 fixed with a second groove 206C in the shank 206B of the nut 206. The retraction spring assembly 209 can thus apply an urging force in the retraction direction (i.e., a retraction force) to the piston 203 via the nut 206 and the second retaining ring 212.

Also fixed to the shank 206B of the nut 206, via a third groove 206D, is a third retaining ring 213. Further, a washer 214 is slidably disposed on the shank 206B between the retraction spring assembly retainer 211 and the third retaining ring 213. FIG. 6 illustrates an initial standby position of the piston 203 relative to the housing 201. In the standby position, assuming the washer 214 is in contact with the retraction spring assembly retainer 211, the washer 214 is spaced apart from the third retaining ring 213 by a predetermined distance X2 which is dependent on the dimensions of various components of the device, but which remains constant regardless of the position of the split ring 205 with respect to the housing 201. The predetermined distance X2 is set as the desired distance the piston 203 should move in order to fully engage the brake pad.

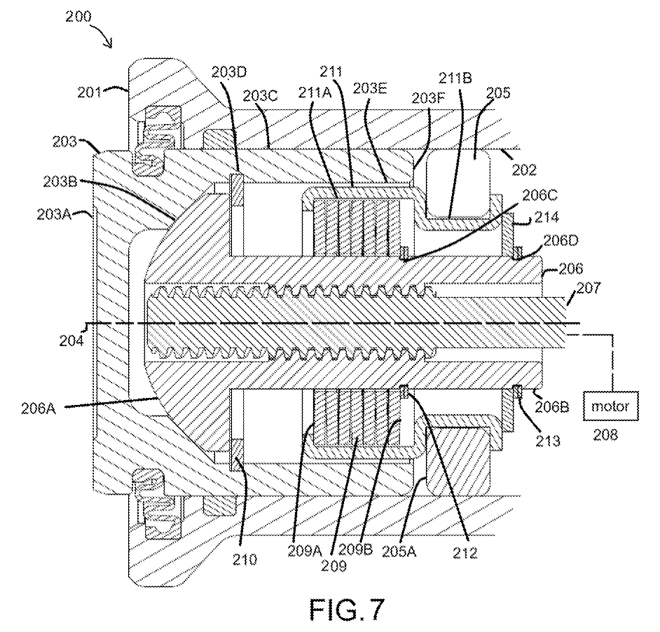

When the driving mechanism moves the piston 203 in the advancement direction from the standby position of FIG. 6, the split ring 205 stays clamped to the housing 201 until the piston 203 has traveled the predetermined distance X2, at which point the washer 214 is sandwiched between the retraction spring assembly retainer 211 and the third retaining ring 213, as illustrated in FIG. 7. Although this position is set as the desired position for full engagement of the brake pad, as discussed above, there is a possibility that the brake pad has worn, or has further worn since the last time the standby position was adjusted.

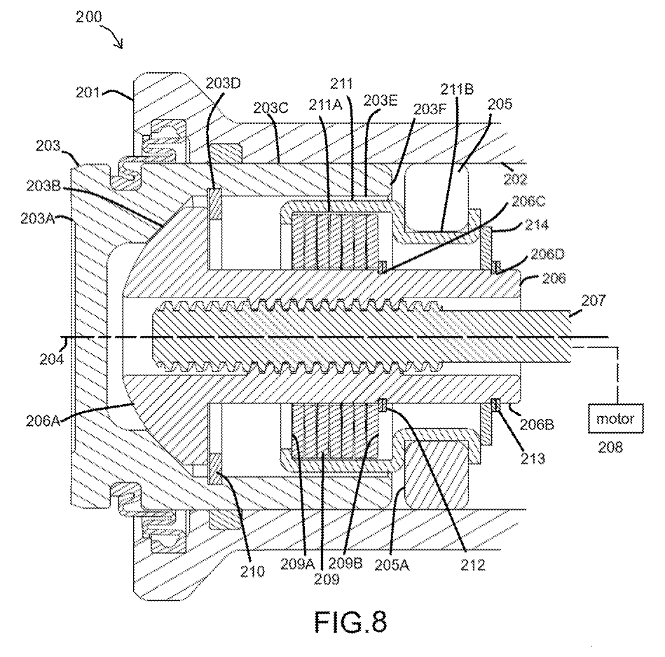

If the piston 203 is then moved further in the advancement direction, for example, because the brake pad has worn, or has further worn since the last time the standby position was adjusted, the friction force due to the clamping force of the split ring 205 on the housing 201 is overcome, and the split ring 205 is urged to advance along with the nut 206 and the piston 203, via an advancement-direction force applied from the third retaining ring 213 to the washer 214, the retraction spring assembly retainer 211, and the split ring 205. FIG. 8 illustrates an example of such a further advanced position, e.g., a position in which the worn or further worn brake pad is fully engaged. The position of the split ring 205 relative to the housing 201 when the piston 203 is at this further advanced position will define a new standby position of the piston 203 relative to the housing 201, as discussed in detail below.

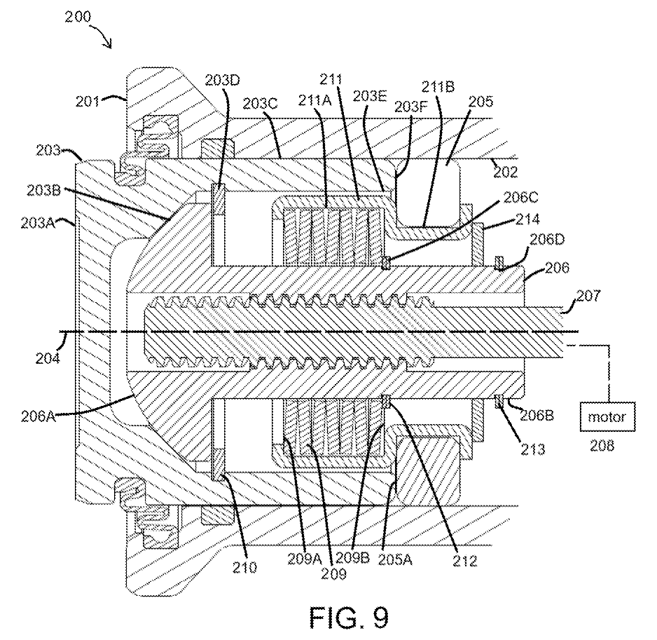

When a retraction force is applied to the piston 203, either by the driving mechanism, or in the event of a power failure, by the retraction spring assembly 209 (via the second retaining ring 212 and the nut 206), the pressing force is discontinued and the piston 203 is moved in the retraction direction. During this movement of the piston 203 in the retraction direction, the split ring 205 remains clamped to the housing 201, and in the case in which the piston 203 had previously moved further than the predetermined distance X2 in the advancement direction, the position at the which the split ring 205 is now clamped to the housing 201 is different the position at the which the split ring 205 was clamped to the housing 201 prior to the movement in the advancement direction. As a result, the position of the piston 203 relative to the housing 201 when the stop surface 203F is in contact with the split ring 205, i.e., the standby position, has changed, as shown in FIG. 9, to account for the wear or further wear of the brake pad. Thus, during subsequent actuations and until additional adjustment is needed, the piston 203 will only need to travel the predetermined distance X2 in the advancement direction to again fully engage the brake pad.

It will be appreciated by those skilled in the art that the disclosure herein can be embodied in other specific forms without departing from the spirit or essential characteristics thereof. The presently-disclosed embodiments are therefore considered in all respects to be exemplary and not restricted. The scope of the invention is indicated by the appended claims rather than the foregoing description and all changes that come within the meaning and range and equivalence thereof are intended to be embraced therein.

What is claimed is:

1. An electromechanical brake actuator, comprising:
a housing defining a bore;
a piston slidably movable within the bore along a longitudinal axis of the bore, the piston having a pressing surface configured to apply a pressing force to a brake pad;
a driving mechanism configured to drive the piston relative to the housing in an advancement direction such that the pressing force is applied and in a retraction direction opposite the advancement direction such that the pressing force is discontinued;
a split ring clamped to one of the housing or the piston and configured to stop movement of the piston relative to the housing in the retraction direction at a standby position of the piston relative to the housing;
wherein the split ring is configured to be positionally fixed to the one of the housing or the piston when the piston moves in the advancement direction from the standby position by a distance less than a predetermined distance;
wherein the split ring is configured to be positionally fixed to the other of the housing or the piston when the piston moves in the advancement direction from the standby position by a distance greater that the predetermined distance, thereby adjusting the standby position.

2. The electromechanical brake actuator according to claim 1, wherein the driving mechanism comprises a screw configured to be rotated about the longitudinal axis by a motor, and a nut threaded to a screw and configured to linearly move along the longitudinal axis as the screw rotates about the longitudinal axis.

3. The electromechanical brake actuator according to claim 2, wherein the nut includes a head sandwiched between a contact surface of the piston and a retaining ring fixed to the piston.

4. The electromechanical brake actuator according to claim 1, further comprising a retraction spring assembly configured to apply a retraction force urging the piston in the retraction direction relative to the housing.

5. The electromechanical brake actuator according to claim 4, wherein the retraction spring assembly comprises one or more stacked disc springs.

6. An electromechanical brake actuator, comprising:
a housing defining a bore;
a piston slidably movable within the bore along a longitudinal axis of the bore, the piston having a pressing surface configured to apply a pressing force to a brake pad;
a driving mechanism configured to drive the piston relative to the housing in an advancement direction such that the pressing force is applied and in a retraction direction opposite the advancement direction such that the pressing force is discontinued;
a split ring clamped to an outer surface of the piston and configured to stop movement of the piston relative to the housing in the retraction direction at a standby position of the piston relative to the housing;
wherein the split ring is configured to move with the piston when the piston moves in the advancement direction from the standby position by a distance less than a predetermined distance;
wherein the piston is configured to move relative to the split ring when the piston moves in the advancement direction from the standby position by a distance greater that the predetermined distance, thereby adjusting the standby position.

7. The electromechanical brake actuator according to claim 6, wherein the driving mechanism comprises a screw configured to be rotated about the longitudinal axis by a motor, and a nut threaded to a screw and configured to linearly move along the longitudinal axis as the screw rotates about the longitudinal axis.

8. The electromechanical brake actuator according to claim 7, wherein the nut includes a head sandwiched between a contact surface of the piston and a retaining ring fixed to the piston.

9. The electromechanical brake actuator according to claim 6, further comprising a retraction spring assembly configured to apply a retraction force urging the piston in the retraction direction relative to the housing.

10. The electromechanical brake actuator according to claim 9, wherein the retraction spring assembly comprises one or more stacked disc springs.

11. The electromechanical brake actuator according to claim 9, wherein the split ring has an advancement-side surface in contact with the retraction spring assembly and facing a stepped surface in the housing, a distance between the advancement-side surface and the stepped surface when the piston is in the standby position being the predetermined distance.

12. The electromechanical brake actuator according to claim 6, wherein the split ring has a retraction-side surface facing a stop surface of the housing, the split ring configured to stop movement of the piston relative to the housing in the retraction direction when the retraction-side surface contacts the stop surface.

13. An electromechanical brake actuator, comprising:
a housing defining a bore;
a piston slidably movable within the bore along a longitudinal axis of the bore, the piston having a pressing surface configured to apply a pressing force to a brake pad;
a driving mechanism configured to drive the piston relative to the housing in an advancement direction such that the pressing force is applied and in a retraction direction opposite the advancement direction such that the pressing force is discontinued;
a split ring clamped to an inner surface of the housing and configured to stop movement of the piston relative to the housing in the retraction direction at a standby position of the piston relative to the housing;
wherein the piston is configured to move relative to the split ring when the piston moves in the advancement direction from the standby position by an distance less than a predetermined distance;
wherein the split ring is configured to move with the piston when the piston moves in the advancement direction from the standby position by a distance greater that the predetermined distance, thereby adjusting the standby position.

14. The electromechanical brake actuator according to claim 13, wherein the driving mechanism comprises a screw configured to be rotated about the longitudinal axis by a motor, and a nut threaded to a screw and configured to linearly move along the longitudinal axis as the screw rotates about the longitudinal axis.

15. The electromechanical brake actuator according to claim 14, wherein the nut includes a head sandwiched between a contact surface of the piston and a first retaining ring fixed to the piston.

16. The electromechanical brake actuator according to claim 13, further comprising a retraction spring assembly configured to apply a retraction force urging the piston in the retraction direction relative to the housing.

17. The electromechanical brake actuator according to claim 16, wherein the retraction spring assembly comprises one or more stacked disc springs.

18. The electromechanical brake actuator according to claim 16, wherein:
the split ring is fixed relative to the longitudinal axis to a retraction spring assembly retainer that retains the retraction spring assembly; and
the retraction spring assembly has a first end in engagement with the retraction spring assembly retainer and a second end in engagement with a second retaining ring fixed to a shank of the nut, the retraction spring assembly applying the retraction force to the piston via the nut and the second retaining ring.

19. The electromechanical brake actuator according to claim 18, further comprising
a third retaining ring fixed to the shank of the nut; and
a washer disposed on the shank between the retraction spring assembly retainer and the third retaining ring;
wherein a distance between the washer and the third retaining ring when the washer is in contact with the retraction spring assembly retainer and the piston is in the standby position is the predetermined distance.

20. The electromechanical brake actuator according to claim 13, wherein the split ring has an advancement-side surface facing a stop surface of the piston, the split ring configured to stop movement of the piston relative to the housing in the retraction direction when the stop surface contacts the advancement-side surface.
